(19) United States
(12) Patent Application Publication
(10) Pub. No.: US 2014/0235811 A1
(43) Pub. Date: Aug. 21, 2014

(54) RAW MATERIALS AND METHODS OF MANUFACTURING BIO-BASED EPOXY RESINS

(71) Applicant: INDUSTRIAL TECHNOLOGY RESEARCH INSTITUTE, Hsinchu (TW)

(72) Inventors: Chia-Wei YANG, Zhubei City (TW); Yuung-Ching SHEEN, Hsinchu City (TW); Su-Mei Chen WEI, Hsinchu City (TW); Jer-Young CHEN, Hsinchu City (TW); Yih-Her CHANG, Hsin Chu County (TW); Yi-Ting WANG, Taichung City (TW)

(73) Assignee: INDUSTRIAL TECHNOLOGY RESEARCH INSTITUTE, Hsinchu (TW)

(21) Appl. No.: 14/264,774

(22) Filed: Apr. 29, 2014

Related U.S. Application Data
(63) Continuation-in-part of application No. 13/015,082, filed on Jan. 27, 2011, now abandoned.

(30) Foreign Application Priority Data
Dec. 14, 2010 (TW) 99143654

(51) Int. Cl. C09D 163/00; C08G 59/02

(52) U.S. Cl. CPC C09D 163/00; C08G 59/02
USPC 527/401; 427/331

(57) ABSTRACT

Disclosed are methods for manufacturing bio-based epoxy resins. The raw materials of the resins include lignin, polyol, solvent, catalyst, acid anhydride, and multi-epoxy compound. The methods of manufacturing the resins include evenly mixing the lignin, the polyol, the catalyst, and the solvent together to form a mixture. The acid anhydride is added to the mixture to process esterification for forming an intermediate product. The multi-epoxy compound is added to the intermediate product to process epoxidation for forming the bio-based epoxy resins. The bio-based epoxy resin has excellent compatibility with the solvent, such that the solvent can be added to the bio-based epoxy resins to form coatings having a tunable solid content. As a result, the coating can be applied to the surfaces of every type of base material.

### CROSS REFERENCE TO RELATED APPLICATIONS

This Application is a Continuation-In-Part of pending U.S. patent application Ser. No. 13/015,082, filed on Jan. 27, 2011 and entitled “Raw materials and Methods of manufacturing bio-based epoxy resins”, which claims priority of Taiwan Patent Application No. 099143654, filed on Dec. 14, 2010, the entirety of which is incorporated by reference herein.

### TECHNIQUE FIELD

The present invention relates to lignin, and in particular relates to modified epoxy resins utilizing lignin, and raw materials and methods of manufacturing the modified epoxy resins.

### BACKGROUND

Gasoline supplement is running dry, such that the gasoline costs are rising. Production, usage, and waste of gasoline products are not environmentally friendly and results in a lot of carbon dioxide and pollutants. As such, plant type and bio-based materials is a major area being developed for replacing gasoline materials which are used as raw materials in critical industries. In plants, a content ration of lignin is just less than a content ratio of cellulose. A lignin source can be straw, pulp black, wood flour, lumber, or any plants. According to methods of obtaining the lignin, the lignin can be classified to alkali lignin, ororganosolv lignin, lignosulfonate, and the likes. Compared to other lignins, lignosulfonate can be industrially mass produced and is the most readily and stably sourced lignin material around. Currently, lignin is applied in additives, dispersive agents, and for organic synthesis, wherein lignin-based epoxy resins arc mainly formed.

Lignin-based epoxy resins are classified into two major types, depending on whether the lignin serves as a main agent or a curing agent. For lignin serving as the main agent, there are two preparation methods thereof. In the first method, the lignin is polymerized with chloropropylene oxide under an alkaline condition. In the second method, a lignin-acid anhydride pre-polymer is reacted with an epoxy compound. The main agent products of the method may be used to collocate with different curing agents. For lignin serving as the curing agent, there are three preparation methods thereof In the first method, the lignin is not modified. In the second method, the lignin is modified by phenol to tune a hydroxyl ratio thereof. In the third method, the lignin is modified by polymerizing the lignin with polyol and acid anhydride to form a lignin-acid anhydride pre-polymer. These products of the methods may be used to collocate with different epoxy resin main agents. Although lignosulfonate source is stable, wide, and low cost, the stewing process of sulfite for manufacturing the lignosulfonate will change its structure, reduce its reactivity, and decrease its solubility in several organic solvents. In other words, application of lignosulfonate is difficult. The conventional lignosulfonate must be modified and purified by complicated processes, and then polymerized with chloropropylene oxide. Lignin inherently has two hydroxyl groups, e.g. hydroxyl groups on alkyl chains or phenol groups on aromatic rings, with different epoxidation rates. Moreover, the lignosulfonate with changed structure and low reactivity is difficult to epoxidize, and therefore influencing the epoxy resin performance.

For solving the described problems, several patents have disclosed reacting polyols, acid anhydrides, and lignins, together, to form lignin-acid anhydride pre-polymers, such that reactivity and compatibility of the lignin and the solvents are enhanced. Thereafter, the pre-polymers are used to prepare lignin-based epoxy resins. In China Patent No. CN101348558, an enzymolysis lignin (ororganosolv lignin) is used to prepare a lignin-based epoxy resin having an epoxy value of 0.24 mol/100 g to 0.67 mol/100 g. However, when the organosolv lignin used, is replaced with lignosulfonate, a lignin-based epoxy resin cannot be produced. In Japan Publication No. JP2006/028528, ethylene glycol and acid anhydride are used to modify an enzymolysis lignin (or alkali lignin) to form a lignin-based acid anhydride pre-polymer. The pre-polymer may serve as a multi-carboxylic acid curing agent. A biodegradable epoxy resin can be prepared by using the curing agent and several epoxy resins (main agents). However, the publication fails to teach that the lignin can be replaced with lignosulfonate.

Accordingly, a novel method of modifying lignins to form a lignin-based and bio-based epoxy resin with low cost and high performance is called-for.

### SUMMARY

One embodiment of the invention provides raw materials of a bio-based epoxy resin, comprising: 100 parts by weight of lignin; 0 to 300 parts by weight of polyol; 200 to 1800 parts by weight of a solvent; 0 to 30 parts by weight of a catalyst; 10 to 700 parts by weight of acid anhydride; and 50 to 1000 parts by weight of a multi-epoxy compound.

One embodiment of the invention provides a method of manufacturing a bio-based epoxy resin, comprising: mixing 100 parts by weight of lignin, 0 to 300 parts by weight of polyol, 0 to 30 parts by weight of a catalyst, and 200 to 1800 parts by weight of a solvent to form a mixture; adding 10 to 700 parts by weight of acid anhydride to the mixture, which is heated and reacted to form an intermediate product; adding 50 to 1000 parts by weight of a multi-epoxy compound to the intermediate product, which is heated and reacted to form a bio-based epoxy resin solution; and removing the solvent of the bio-based epoxy resin solution to form a bio-based epoxy resin.

### DETAILED DESCRIPTION OF THE INVENTION

In the following detailed description, for purposes of explanation, numerous specific details are set forth in order to provide a thorough understanding of the disclosed embodiments. It will be apparent, however, that one or more embodiments may be practiced without these specific details.

In one embodiment, a method of forming a bio-based epoxy resin is provided. First, lignin, polyol, catalyst, and solvent are mixed to form a mixture. Acid anhydride is added to the mixture, which is heated and reacted to form a homogeneous solution of a modified lignin intermediate product. In one embodiment, the process of heating and reacting is performed at a temperature of 110° C. to 160° C. for a period of 2 hours to 5 hours. An overly high temperature and/or an overly long period will not obviously enhance ring-opening polymerization in the process of heating and reacting. An overly low temperature and/or an overly short period will not complete ring-opening polymerization in the process of heating and reacting.

Polyol is a compound having at least two hydroxyl groups, such as diol (e.g. ethylene glycol or propylene glycol, or triol (e.g. glycerol), or combinations thereof. The polyol may serve as a surfactant between a solvent and the lignin, such that an original lignin without modification can be a little bit dissolved in a solution. Furthermore, the polyol reacts with the acid anhydride to process ring-opening polymerization. Based on 100 parts by weight of the lignin, an amount of the polyol is 0 to 300 parts by weight thereof, and preferably 10 to 50 parts by weight thereof. An overly high amount of the polyol influences the reactivity of the acid anhydride and the lignin.

The catalyst is the so-called Lewis acid, such as phenylsulfonic acid or derivatives thereof (e.g. toluenesulfonic acid), sulfuric acid, triphenyl phosphine, or combinations thereof. A little catalyst may help with condensation reaction. Based on 100 parts by weight of the lignin, an amount of the catalyst is 0 to 30 parts by weight thereof, and preferably 10 to 20 parts by weight thereof. An overly high amount of the catalyst cannot dramatically help the condensation reaction but influence a subsequent epoxidation.

The solvent can be polar aprotic solvent such as N,N-dimethylformamide (DMF) or dimethylacetamide (DMAc). Generally, the lignin is dissolved in water rather than most solvents, but embodiments of the invention reverse normal ways. The lignin and other reagents are firstly dispersed in the solvent, and the modified lignin is then gradually dissolved in the solvent during reaction. In one embodiment, the lignosulfonate is chosen to be modified and dissolved in the solvent. Based on 100 parts by weight of the lignin, an amount of the solvent is 200 to 1800 parts by weight thereof, and preferably 400 to 600 parts by weight thereof. An overly high amount of the solvent will reduce a solid content of the reaction product, which is not beneficial when adjusting material ratios of the product in subsequent steps. An overly low amount of the solvent leads to an overly high reaction viscosity and poor compatibility between the reactants and the solvent.

The acid anhydride can be an organic compound having at least one acid anhydride group, such as maleic acid anhydride, 1,2,4,5-benzenetetracarboxylic anhydride, trimellitic anhydride, derivatives thereof, or combinations thereof The hydroxyl groups of the lignin may react with the acid anhydride to form carboxylic acid groups. The terminal carboxylic acid group may further react with the hydroxyl groups of the polyol, and another hydroxyl group of the polyol may react with the other acid anhydride to form carboxylic acids. The above reaction is the so-called esterification polymerization. Note that a lot of un-reacted carboxylic acid groups of the acid anhydride will remain after the esterification polymerization, and a lot of un-reacted hydroxyl groups of the polyol will remain after the esterification polymerization, too. Based on 100 parts by weight of the lignin, an amount of the acid anhydride is 10 to 700 parts by weight thereof, and preferably 100 to 160 parts by weight thereof. An overly high amount of the acid anhydride influences epoxidation modification in subsequent steps. An overly low amount of the acid anhydride lowers epoxidation modification effect of the lignin.

A multi-epoxy compound is added to the homogeneous solution of the modified. lignin intermediate product, which is heated and reacted to form a bio-based epoxy resin solution. In one embodiment, the process of heating and reacting is performed at a temperature of 70° C. to 150° C. for a period of 0.5 hour to 6 hours. In another embodiment, the process of heating and reacting is performed by a two-step heating method, wherein the first step is performed at a temperature at 70° C. to 150° C. for a period of 0.5 hour to 6 hours, and the second step is performed at a temperature at 150° C. for a period of 1 hour to 6 hours.

The multi-epoxy compound can be an organic compound having at least two epoxy groups, such as glycidyl ether, diglycidyl ether, bisphenol A diglycidyl ether, epoxidized vegetable oil, derivatives thereof, or combinations thereof. Part of the epoxy groups of the multi-epoxy compound react with the carboxylic acid groups and/or the hydroxyl groups of the pre-modified lignin to form the bio-based epoxy resin solution. It should be understood that the bio-based epoxy resin has un-reacted carboxylic acid groups, hydroxyl groups, and epoxy resins. In one embodiment, the multi-epoxy compound has an epoxy value of 0.02 mol/100 g to 0.8 mol/100 g. An overly low epoxy value of the multi-epoxy compound reduces the epoxidation reactivity and ratio of the lignin. Based on 100 parts by weight of the lignin, an amount of the multi-epoxy compound is 50 to 1000 parts by weight thereof, and preferably 100 to 300 parts by weight thereof. An overly amount of the multi-epoxy compound would require additional curing agents to totally crosslink the bio-based epoxy resin applied as a coating. An overly low amount of the multi-epoxy compound reduces the epoxidation ratio, thereby degrading the properties of the bio-based epoxy resin applied as a coating.

The bio-based epoxy resin solution can directly serve as a coating, or an additional solvent can be added thereto for tuning its solid content. The bio-based epoxy resin solution can be coated on a substrate such as glass, ceramic, stone, plastic, metal, or polymer, and then dried to form a film. The coating method includes spin coating, dip coating, brush coating, spray coating, roll coating, or combinations thereof. In one embodiment, drying or removing the solvent of the bio-based epoxy resin solution is performed at a temperature of 150° C. to 200° C. for a period of 0.5 hour to 3 hours.

In one embodiment, 1 to 4 parts by weight of a crosslinker is further added to 4 parts by weight of the bio-based epoxy resin solution before the step of removing the solvent of the bio-based epoxy resin solution. The crosslinker can be amine, anhydride, polyamide resin, phenolic resin, or biomass, wherein the biomass includes lignin, carbohydrate, starch, or cellulose. The crosslinker may help the bio-based epoxy resin crosslink, thereby improving the durability and chemical resistance of the film. An overly high amount of the crosslinker may degrade the stability of the coating, and unreacted residual crosslinker may migrate to the film surface, thereby degrading adhesion and chemical resistance of the film.

As described above, the raw material of the embodiments can be mass produced with stable supplements. The compatibility of the lignin and the solvent and the epoxidation rate of the lignin can be enhanced by simple modification, such that the modified lignin is suitable to be coated on metal building materials. The bio-based epoxy resin may replace the conventional gasoline-based epoxy resin. Furthermore, the bio-based epoxy resin can be developed as an epoxy resin free of bisphenol A for application in the lining of food cans.

Below, exemplary embodiments will he described in detail with reference accompanying drawings so as to be easily realized by a person having ordinary knowledge in the art. The inventive concept may be b tied in various forms without being limited to the exemplary embodiments set forth herein. Description of well-known parts are omitted for clarity, and like reference numerals refer to like elements throughout.

### EXAMPLES

### Example 1

40 g of lignosulfonate (DP651, commercially available from Borregaard), 8 g of ethylene glycol, 5.6 g of 4-toluenesulfonic acid, and 200 g of DMF were mixed to form a mixture. Subsequently, 54.3 g of 1,2,4,5-benzenetetracarboxylic anhydride was added to the mixture, which was heated and reacted at 130° C. for 3 hours, thereby forming a homogeneous solution of a modified lignosulfonate intermediate product. 45.6 g of a multi-epoxy compound (NPEL127, epoxy value of 0.5453 mol/100 g, commercially available from Nanya Plastic. Co.) was added to the homogeneous solution of the modified lignosulfonate intermediate product, which was heated and reacted at 130° C. for 1 hours and then 150° C. for 1 hour. As such, a bio-based epoxy resin solution was obtained. The solvent of the bio-based epoxy resin was removed to obtain a bio-based epoxy resin having an epoxy value of 0.070 mol/100 g. A co-solvent of 5 parts by volume of DMF and 1 part by volume of methoxy polyethylene glycol (mPEG) was added to the bio-based epoxy resin to form a coating having a solid content of 30%. The coating was coated on an aluminum foil by a wire rod, and then heated to 180° C. for 1 hour to solidify the coating, remove the solvent thereof, and intermolecular crosslink and/or intramolecular crosslink the epoxy groups and hydroxyl groups of the bio-based epoxy resin. The coating was solidified to form a film having a smooth and bright appearance, a pencil hardness of H, an adhesiveness of 100/100 as measured by a scotch tape test, and a solvent rub resistance for mPEG, isopropanol, or DMAc.

### Example 2

40 g of lignosulfonate (DP651, commercially available from Borregaard), 8 g of ethylene glycol, 5.6 g of 4-toluenesulfonic acid, and 200 g of DMF were mixed to form a mixture. Subsequently, 54.3 g of 1,2,4,5-benzenetetracarboxylic anhydride was added to the mixture, which was heated and reacted at 130° C. for 3 hours, thereby forming a homogeneous solution of a modified lignosulfonate intermediate product. 40 g of a multi-epoxy compound (epoxidized soybean oil, epoxy value of 0.4125 mol/100 g) was added to the homogeneous solution of the modified lignosulfonate intermediate product, which was heated and reacted at 130° C. for 1 hours and then 150° C. for 1 hour. As such, a bio-based epoxy resin solution was obtained. The solvent of the bio-based epoxy resin was removed to obtain a bio-based epoxy resin having an epoxy value of 0.063 mol/100 g. A co-solvent of 5 parts by volume of DMF and 1 part by volume of mPEG was added to the bio-based epoxy resin to form a coating having a solid content of 30%. The coating was coated on an aluminum foil by a wire rod, and then heated to 180° C. for 1 hour to solidify the coating, remove the solvent thereof, and intermolecular crosslink and/or intramolecular crosslink the epoxy groups and hydroxyl groups of the bio-based epoxy resin. The coating was solidified. to form a film having a smooth and bright appearance, a pencil hardness of H, an adhesiveness of 100/100 as measured by a scotch tape test, and a solvent rub resistance for isopropanol or DMAc, but no solvent rub resistant for mPEG. Compared to Example 1, the film in Example 2 lacked of solvent rub resistance for mPEG should come from the low reactivity at the high temperature solidification. Therefore, the film had a low crosslink density and low solvent rub resistance.

### Comparative Example 1

25 g of lignosulfonate (DP651, commercially available from Borregaard), 12.5 g of ethylene glycol, and 7.5 g of sulfuric acid (50% aqueous solution) were mixed to form a mixture. Subsequently, 25 g of 1,2,4,5-benzenetetracarboxylic anhydride was added to the mixture, which was heated and reacted at 130° C. for 3 hours, thereby forming a homogeneous liquid. 25 g of a multi-epoxy compound (epoxidized soybean oil, epoxy value of 0.4125 mol/100 g) was added to the homogeneous liquid, which was heated and reacted at 130° C. for 1 hours and then 150° C. for 1 hour. As such, a heterogeneous and dark brown liquid was obtained. The heterogeneous liquid stood to separate into two layers, which could not be coated on any substrate.

### Example 3

40 g of lignosulfonate (DP651, commercially available from Borregaard), 6 g of ethylene glycol, 20 g of 1,4-butanediol, and 138 g of dimethylamide (DMAc) were mixed to form a mixture. Subsequently, 60.83 g of 1,2,4,5-benzenetetracarboxylic anhydride was added to the mixture, which was heated and reacted at 140° C. for 3 hours, thereby forming a homogeneous solution of a modified lignosulfonate intermediate product. 44.93 g of a multi-epoxy compound (Ethylene glycol diglycidyl ether, commercially available from TCI) was dissolved in 35 g of DMAc. The ethylene glycol diglycidyl ether solution was added to the homogeneous solution of the modified lignosulfonate intermediate product, which was heated and reacted at 110° C. for 1.5 hours. As such, a bio-based epoxy resin homogeneous solution was obtained. 1 g of a crosslinker (8215-BX-50, commercially available from Eternal Company, Taiwan) was added to 4 g of the bio-based epoxy resin homogeneous solution, and stirred for a while to obtain a bio-based epoxy resin coating. The coating was coated on a tinplate sheet by a wire rod, and then heated to 190° C. for 11 minutes to solidify the coating, remove the solvent thereof, and intermolecular crosslink and/or intramolecular crosslink the epoxy groups and hydroxyl groups of the bio-based epoxy resin. The coating was solidified to form a film having a smooth and bright appearance, a pencil hardness of 3H, an adhesiveness of 100/100 as measured by a scotch tape test.

### Example 4

40 g of alkali lignin (commercially available from Laiher Company), 4 g of ethylene glycol, 98 g of dimethylacetamide (DMAc) were mixed to form a mixture. Subsequently, 4.78 g of trimellitic anhydride (TMA) was added to the mixture, which was heated and reacted at 150° C. for 3 hours, thereby forming a homogeneous solution of a modified alkali lignin intermediate product. 46.78 g of a multi-epoxy compound (BE-188, epoxy value of 0.5319 mol/100 g, commercially available from Chang Chun Group) was dissolved in 18 g of DMAc. The BE-188 solution was added to the homogeneous solution of the modified alkali lignin intermediate product, which was heated and reacted at 100° C. for 1 hour. As such, a bio-based epoxy resin homogeneous solution was obtained. 1 g of a crosslinker (BL-3175-SN, commercially available. from Bayer) was added to 4 g of the bio-based epoxy resin homogeneous solution, and stirred for a while to obtain a bio-based epoxy resin coating. The coating was coated on a galvanized sheet metal by a wire rod, and then heated to 190° C. for 11 minutes to solidify the coating, remove the solvent thereof, and intermolecular crosslink and/or intramolecular crosslink the epoxy groups and hydroxyl groups of the bio-based epoxy resin. The coating was solidified to form a film having a smooth and bright appearance, a pencil hardness of 3H, an adhesiveness of 100/100 as measured by a scotch tape test.

### Example 5

20 g of alkali lignin (MKBH3445, commercially available from Aldrich), 20 g of ethylene glycol, 1 g of triphenylphosphine, and 149g of propylene glycol mono-methyl ether (PGME) were mixed to form a mixture. Subsequently, 38.95 g of maleic anhydride was added to the mixture, which was heated and reacted at 120° C. for 3 hours, thereby forming a homogeneous solution of a modified alkali lignin intermediate product. 74.68 g of a multi-epoxy compound (BE-188) was dissolved in 40 g of PGME. The BE-188 solution was added to the homogeneous solution of the modified alkali lignin intermediate product, which was heated and reacted at 90° C. for 1 hour. As such, a bio-based epoxy resin homogeneous solution was obtained. 1 g of a crosslinker (8215-BX-50) was added to 4 g of the bio-based epoxy resin homogeneous solution, and stirred for a while to obtain a bio-based epoxy resin coating. The coating was coated on a tinplate sheet by a wire rod, and then heated to 190° C. for 15 minutes to solidify the coating, remove the solvent thereof, and intermolecular crosslink and/or intramolecular crosslink the epoxy groups and hydroxyl groups of the bio-based epoxy resin. The coating was solidified to form a film having a smooth and bright appearance, a pencil hardness of H, an adhesiveness of 100/100 as measured by a scotch tape test.

### Example 6

20 g of alkali(commercially available from Chung Hwa pulp Corporation) and 47 g of DMAc were mixed to form a mixture. Subsequently, 11.77 g of maleic anhydride was added to the mixture, which was heated and reacted at 160° C. for 3 hours, thereby forming a homogeneous solution of a modified alkali lignin intermediate product. 14.1 g of a multi-epoxy compound (BE-188) was dissolved in 9 g of DMAc. The BE-188 solution was added to the homogeneous solution of the modified alkali lignin intermediate product, which was heated and reacted at 90° C. for 1 hour. As such, a bio-based epoxy resin homogeneous solution was obtained. 2.4 g of a crosslinker (8215-BX-50) was added to 8 g of the bio-based epoxy resin homogeneous solution, and stirred for a while to obtain a bio-based epoxy resin coating. The coating was coated on a tinplate sheet by a wire rod, and then heated to 190° C. for 15 minutes to solidify the coating, remove the solvent thereof, and intermolecular crosslink and/or intramolecular crosslink the epoxy groups and hydroxyl groups of the bio-based epoxy resin. The coating was solidified to form a film having a smooth and bright appearance, a pencil hardness of 2H, an adhesiveness of 80/100 as measured by a scotch tape test.

### Example 7

20 g of alkali lignin (commercially available from Chung Hwa pulp Corporation), 20 g of EG, and 177 g of DMAc were mixed to form a mixture. Subsequently, 62.32 g of maleic anhydride was added to the mixture, which was heated and reacted at 160° C. for 3 hours, thereby forming a homogenous solution of a modified alkali lignin intermediate product. 74.68 g of a multi-epoxy compound (BE-188) was dissolved in 40 g of DMAc. The BE-188 solution was added to the homogeneous solution of the modified alkali lignin intermediate product, which was heated and reacted at 90° C. for 1 hour.

### Example 8

2.4 g of crosslinkers (8215-BX-50, BL-3175-SN, or Cymel 303 commercially available from Cytec Company) were added to 8 g of the bio-based epoxy resin homogeneous solution in Example 7, respectively, and stirred for a while to obtain three bio-based epoxy resin coatings. The three coatings were coated on a tinplate sheet by a wire rod, respectively, and then heated to 190° C. for 15 minutes to solidify the coatings, remove the solvent thereof, and intermolecular crosslink and/or intramolecular crosslink the epoxy groups and hydroxyl groups of the bio-based epoxy resin. The coatings were solidified to form films having a smooth and bright appearance, and pencil hardness of 4H (with the crosslinker 8215-BX-50), 2H (with the crosslinker BL-3175-SN), or 2H (with the crosslinker Cymel 303).

### Example 9

30 g of organosolv lignin (extracted from eucalyptus tree) was added to 5% NaOH aqueous solution and 8 equivalents of 1-chloro-2,3-epoxypropane, and heated and reacted at 60° C. for 3 hours, thereby precipitating a lignin-based epoxy resin (E-Lignin-990511). The lignin-based epoxy resin was diluted by PGME to form a coating with a solid content of 30%. The coating was coated on an aluminum sheet by a wire rod, and then heated to 180° C. for 30 minutes to solidify the coatings, remove the solvent thereof, and intermolecular crosslink and/or intramolecular crosslink the epoxy groups and hydroxyl groups of the bio-based epoxy resin. The coating was solidified to form a film having a smooth and bright appearance, a pencil hardness of H, an adhesiveness of 100/100 as measured by a scotch tape test, and a solvent rub resistance for PGME, isopropanol, methanol, or ethanol.

### Example 10

lignin-based epoxy resin (E-Lignin-990511) in Example 9 serving as major agent, the original organosolv lignin (extracted from eucalyptus tree) serving as a crosslinker, and PGME serving as a solvent were mixed to form a coating. The coating was coated on an aluminum sheet by a wire rod, and then heated to 180° C. for 30 minutes to solidify the coatings and remove the solvent thereof When the major agent and the crosslinker had a weight ratio of 1/1 to 2/1, the coating was solidified to form a film having a smooth and bright appearance, a pencil hardness of H, adhesiveness of 100/100 as measured by a scotch tape test, and a solvent rub resistance for PGME, isopropanol, methanol, or ethanol. It will be apparent to those skilled in the art that various modifications and variations can be made to the disclosed methods and materials. It is intended that the specification and examples be considered as exemplary only, with a true scope of the disclosure being indicated by the following claims and their equivalents.

What is claimed is:

1. Raw materials of a bio-based epoxy in, comprising:
100 parts by weight of lignin;
0 to 300 parts by weight of polyol;
200 to 1800 parts by weight of a solvent;
0 to 30 parts by weight of a catalyst;
10 to 700 parts by weight of acid anhydride; and
50 to 1000 parts by weight of a multi-epoxy compound.

2. The raw materials as claimed in claim 1, wherein the lignin comprises alkali lignin, organosolv lignin, lignosulfonate, or combinations thereof.

3. The raw materials as claimed in claim 1, wherein the polyol comprises diol, triol, or combinations thereof.

4. The raw materials as claimed in claim 1, Wherein the solvent comprises a polar aprotic solvent.

5. The raw materials as claimed in claim 1, wherein the catalyst comprises phenylsulfonic acid or derivatives thereof, sulfuric acid, triphenyl phosphine, or combinations thereof.

6. The raw materials as claimed in claim 1, wherein the acid anhydride comprises maleic acid anhydride, 1,2,4,5-benzenetetracarboxylic anhydride, trimellitic anhydride, derivatives thereof, or combinations thereof.

7. The raw materials as claimed in claim 1, wherein an amount of the multi-epoxy compound comprises glycidyl ether, diglycidyl ether, bisphenol A diglycidyl ether, epoxidized vegetable oil, derivatives thereof, or combinations thereof.

8. The raw materials as claimed in claim 1, wherein the multi-epoxy compound has an epoxy value of 0.02 mol/100 g to 0.8 mol/100 g.

9. A method of manufacturing a bio-based epoxy resin, comprising:
mixing 100 parts by weight of lignin, 0 to 300 parts by weight of polyol, 0 to 30 parts by weight of a catalyst, and 200 to 1800 parts by weight of a solvent to form a mixture;
adding 10 to 700 parts by weight of acid anhydride to the mixture, which is heated and reacted to form an intermediate product;
adding 50 to 1000 parts by weight of a multi-epoxy compound to the intermediate product, which is heated and reacted to form a bio-based epoxy resin solution; and
removing the solvent of the bio-based epoxy resin solution to form a bio-based epoxy resin.

10. The method as claimed in claim 9, further comprising adding 1 to 4 parts by weight of a crosslinker to 4 parts by weight of the bio-based epoxy resin solution before the step of removing the solvent of the bio-based epoxy resin solution to form a bio-based epoxy resin.

11. The method as claimed in claim 10, wherein the crosslinker includes amine, anhydride, polyamide resin, phenolic resin, or biomass, wherein the biomass includes lignin, carbohydrate, starch, or cellulose.

12. The method as claimed in claim 9, wherein the bio-based epoxy resin has an epoxy value of 0.01 mol/100 g to 0.2 mol/100 g.

13. The method as claimed in claim 9, wherein the step of adding the acid anhydride to the mixture, which is heated and reacted to form the intermediate product, is performed at 110° C. to 160° C. for 2 hours to 5 hours.

14. The method as claimed in claim 9, wherein the step of adding the multi-epoxy compound to the intermediate product, which is heated and reacted to form the bio-based epoxy resin solution, is performed at 70° C. to 150° C. for 0.5 hour to 6 hours.

15. The method as claimed in claim 13, wherein the bio-based epoxy resin solution is further heated and reacted at 150° C. for 1 hour to 6 hours after the step of adding the multi-epoxy compound to the intermediate product, which is heated and reacted to form the bio-based epoxy resin solution being performed at 70° C. to 150° C. for 0.5 hour to 6 hours.

16. The method as claimed in claim 9, wherein the step of removing the solvent of the bio-based epoxy resin solution is performed by baking the bio-based epoxy resin solution at 150° C. to 200° C. for 0.5 hour to 3 hours.

17. The method as claimed in claim 9, further comprising a step of coating the bio-based epoxy resin solution on a substrate before the step of removing the solvent of the bio-based epoxy resin solution.

18. The method as claimed in claim 16, wherein the step of coating the bio-based epoxy resin on the substrate comprises spin coating, dip coating, brush coating, spray coating, roll coating, or combinations thereof.

19. The method as claimed in claim 16, wherein the substrate comprises glass, ceramic, stone, plastic, metal, or polymer.
